(19) United States
(12) Patent Application Publication
(10) Pub. No.: US 2010/0262687 A1
(43) Pub. Date: Oct. 14, 2010

(54) DYNAMIC DATA PARTITIONING FOR HOT SPOT ACTIVE DATA AND OTHER DATA

(75) Inventors: Jinmei Shen, Rochester, MN (US); Hao Wang, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/421,697

(22) Filed: Apr. 10, 2009

(51) Int. Cl. G06F 15/173; G06F 12/00; G06F 12/02

(52) U.S. Cl. 709/224; 709/223; 707/E17.032; 707/E17.044; 711/E12.001; 711/E12.002

(57) ABSTRACT

A computer readable medium having executable instructions stored thereon to execute a database partitioning method during a current period of time is provided. The database partition method includes picking current hot spot data keys according to available data, creating hot spot partitions, respectively associated with the hot spot data keys, into which hot spot data is loaded before a start time of the current period of time and creating non-hot spot partitions into which non-hot spot data is loaded before the start time, routing hot spot data requests to the hot spot partitions and non-hot spot data requests to the non-hot spot partitions, and monitoring computing resources to determine if a number of the hot spot partitions is to be increased or decreased and, accordingly, increasing or decreasing the number of the hot spot partitions.

### BACKGROUND

Aspects of the present invention are directed to computing systems and, more particularly, to computing systems employing dynamic data partitioning for hot spot active data and other data.

Database partitioning is commonly employed in computing systems to increase scalability, high availability and performance of the computing systems. Often, database partitioning is combined with application server partitioning that enhances the effects of the data partitioning to achieve a relatively very high level of scalability, availability and performance of the computing systems.

Unfortunately, a problem with database partitioning exists in that most, if not all, current database partitioning approaches (e.g., hash based partitioning and key based partitioning) are applied uniformly to all of the data affecting a computing system at any one time. However, all data are not created equally. For example, the New York Stock Exchange (NYSE) and the National Association of Securities Dealers Automated Quotations (NASDAQ) each have only about 150 stocks that are the most active and which provide about 90% of the daily stock trading volume while the rest of the stocks, which number in the thousands, are active but provide relatively small portions of the daily stock trading volume and changes.

It has been seen that the current database partitioning approaches cannot handle such non-uniform and heterogeneous data activities as efficiently as would be desired. That is, if key based database partitioning is applied uniformly to all of the NYSE and NASDAQ data, the number of partition would undesirably skyrocket with some partitions overloaded with data relating to the most active stocks and with other partitions under loaded with very little traffic. Meanwhile, if hash based database partitioning is applied, hot spot data of the most active stocks at any one time cannot be handled at all.

### SUMMARY

In accordance with an aspect of the invention, a computer readable medium having executable instructions stored thereon to execute a database partitioning method during a current period of time is provided. The method includes picking current hot spot data keys according to available data, creating hot spot partitions, respectively associated with the hot spot data keys, into which hot spot data is loaded before a start time of the current period of time and creating non-hot spot partitions into which non-hot spot data is loaded before the start time, routing hot spot data requests to the hot spot partitions and non-hot spot data requests to the non-hot spot partitions, and monitoring computing resources to determine if a number of the hot spot partitions is to be increased or decreased and, accordingly, increasing or decreasing the number of the hot spot partitions.

In accordance with another aspect of the invention, a computer readable medium having executable instructions stored thereon to execute a database partition method for application thereof before and during a current cycle is provided. The database partition method includes dynamically assigning differing partitioning schemes for correspondingly differing data and data key values based on previous and current traffic and performance data.

In accordance with an aspect of the invention, a computing system is provided and includes a plurality of computing devices, including a first set of one or more computing devices and a second set of one or more computing devices, a host computing device having executable instructions stored thereon to cause the host device to dynamically set up and/or update, based on traffic and performance data, numbers of hot spot and non-hot spot data partitions, into each of which hot spot and non-hot spot data are respectively loaded, to be handled by the first and second sets of the computing devices, respectively, and at least one router to route hot spot data requests to the first set of computing devices and to route non-hot spot data requests to the second set of computing devices.

### BRIEF DESCRIPTIONS OF THE SEVERAL VIEWS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a flow diagram illustrating an exemplary database partition method in accordance with embodiments of the invention;

FIG. 2 is a flow diagram illustrating an exemplary method of routing a client request and changing hot spot key lists and partitions in accordance with further embodiments of the invention;

FIG. 3 is a flow diagram illustrating an exemplary database partition method in accordance with further embodiments of the invention; and

FIG. 4 is a schematic diagram of an exemplary computing system that is configured to execute at least the methods of FIG. 1 or 3.

### DETAILED DESCRIPTION

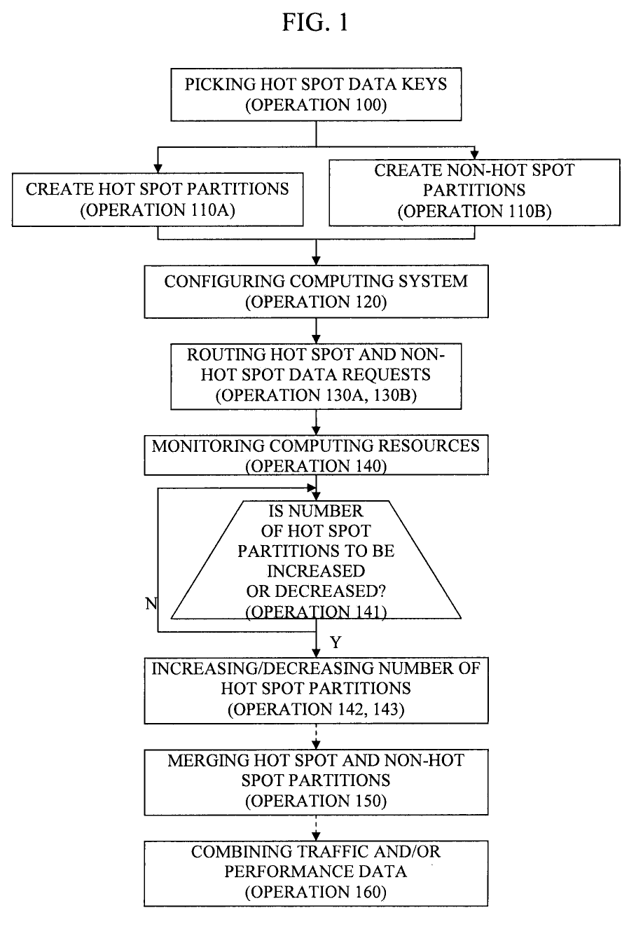

With reference to FIG. 1, a computer readable medium having executable instructions stored thereon to execute a database partitioning method during a current period of time, such as a present business day, is provided. As shown in FIG. 1, the database partitioning method initially includes picking current hot spot data keys (operation 100). Here, as an example, if the traffic and performance data of the last seven business days indicate that Google Inc. stock (GOOG), Yahoo, Inc. stock (YHOO) and Amazon.com, Inc. stock (AMZN) quotes are the most active in terms of trading volume, quote requests, etc., the hot spot data keys that are picked may include business hours keys (i.e., 9:00 AM-4:30 PM on weekdays) and stock symbol keys (i.e., GOOG, YHOO and AMZN). Of course, it is understood that the use of stock market related items is merely exemplary and that the data need not be business or stock market related.

In an embodiment of the invention, the picking of the current hot spot data keys is accomplished periodically in accordance with traffic and/or performance data recorded during, e.g., previous periods of time. That is, if the data in question relates to stock markets, the current hot spot data keys may be picked at a given time before business hours begin on weekdays or, in a further embodiment, at preselected intervals during a time period occurring a given time before business hours on weekdays. As such, the traffic and/or performance data is reflective of, e.g., data request traffic from a set of previous business days.

Where the current hot spot data keys are picked in accordance with the traffic and/or performance data, it is understood that this data identifies a configurable percentage of the most active keys by which key based partitioning can be undertaken. That is, it may be determined that the hot spot data keys are picked for those keys representing the top 20% most active stock symbols from the entire set of stock symbols used by the NYSE and the NASDAQ exchanges over a previous seven business day period for the next business day. Similarly, if it is found to be more desirable to have less numbers of current hot spot data keys, for the following day, it may be determined that the hot spot data keys are picked for only those keys representing the top 10% most active stock symbols.

In accordance with other embodiments of the invention, the current hot spot data keys may also be picked in accordance with historical request records that indicate that certain data are always or substantially more frequently requested than other data, in accordance with anticipated events, such as a company's quarterly financial report and/or by a system administrator. Of course, while each of these methods may be achieved individually, it is understood that any one or all of the methods may be combined with other methods as necessary or advantageous.

Once the current hot spot data keys are picked, hot spot partitions are created (operation 110A). These hot spot partitions may be logical partitions by which computing devices organize data and, in this case, are respectively associated with the hot spot data keys. Thus, if current hot spot data keys include hours of the current business day (9:00 AM to 4:30 PM) and the stock symbol GOOG, a hot spot partition associated with the stock symbol GOOG is created. Subsequently, any and all available data regarded the stock symbol GOOG, including trading data, volume, business information for Google, Inc., etc., is fed into the GOOG hot spot partition. In an embodiment, the feeding of the data is accomplished before the trading day, although this is certainly not required in all aspects. Also, in another embodiment, the feeding of the data is accomplished by way of a loading operation, although it is understood that various data transfer operations are available for the data feeding.

In addition to the creation of the hot spot partitions, non-hot spot partitions are also created (operation 110B) for any data not associated with the hot spot data keys. That is, while the stock symbol GOOG may be picked on any given day as a hot spot data key, thousands of stocks are listed in the NYSE and NASDAQ that do not have relatively high volume and whose associated data can be partitioned, therefore, into the non-hot spot partitions. Once again, in an embodiment, the feeding of the data is accomplished before the trading day, although this is certainly not required in all aspects, and, in another embodiment, the feeding of the data is accomplished by way of a loading operation, although it is understood that various data transfer operations are available for the data feeding.

The data loaded into the hot spot and non-hot spot partitions is partitioned based on various partitioning schemes that may or may not be similar to one another. For example, the hot spot data may be partitioned based on a key based partitioning approach while the non-hot spot data may be partitioned based on a hash based partitioning approach.

Since the hot spot partitions and the non-hot spot partitions are distinguishable from one another by way of header information, traffic and/or performance data, and any other suitable distinguishing data, the method further includes configuring a computing system to insure or otherwise increase a likelihood that computing operations, such as data requests, relating to the hot spot partitions are undertaken by preselected computing devices (operation 120). Since the preselected computing devices can be identified as those computing devices that are faster and/or more efficient computing devices than others within the computing system, the method allows for the data requests relating to the hot spot partitions to be handled relatively quickly and efficiently. This is advantageous given that the hot spot partitions have previously been created in accordance with the understanding that the data loaded in the hot spot partitions is most likely to be active.

In a further embodiment, it is seen that the hot spot and non-hot spot partitions may include logical partitions that can be interchanged and transmitted between computing devices. As a result, it is possible that the identification of the preselected computing devices can be dynamically updated in accordance with current traffic and performance data relating to the computing system. That way, if it is determined that any one particular computing device is overloaded or otherwise has a full queue, another computing device with a relatively light queue can be assigned to handle data requests for a hot spot partition even though the newly assigned computing device may not be the most efficient or high performance computing device within the computing system.

With the hot spot partitions and non-hot spot partitions created, as described above, the method further includes routing hot spot data requests to the hot spot partitions (operation 130A) and non-hot spot data requests to the non-hot spot partitions (operation 130B) by way of at least one or more on-demand router which is coupled to and disposed in signal communication with the computing system.

In addition, during at least the current period of time (e.g., the current business day), computing resources of the computing system, such as processing resources and/or input/output (I/O) resources, are monitored (operation 140) to determine if a number of the hot spot partitions is to be increased or decreased (operation 141) and, accordingly, increasing or decreasing the number of the hot spot partitions (operations 142 and 143) if it is determined that a particular set of data are currently relatively very active. In this way, if a particular stock is undergoing a high trading volume due to a takeover or some other significant business event, it can be determined that a large volume of data requests for that stock will be forthcoming and that the relevant data should be treated as hot spot data.

Following an end of the current period of time, data of the hot spot partitions and the non-hot spot partitions may be merged with one another (operation 150) and traffic and/or performance data, which is recorded during the current period of time, may be added or otherwise combined with traffic and/or performance data recorded during previous periods of time (operation 160). Thus, when the next operation of picking the hot spot data keys is to be undertaken, the data relevant to any newly picked hot spot data keys will be readily available for partitioning. Furthermore, the criteria by which the picking is accomplished will include the latest and, typically, the most relevant traffic and/or performance data available.

In accordance with another aspect of the invention, a computer readable medium having executable instructions stored thereon to execute a database partition method for application thereof before and during a current period of time is provided. Here, the database partition method includes dynamically assigning differing partitioning schemes for correspondingly differing data and data key values based on previous and current traffic and performance data.

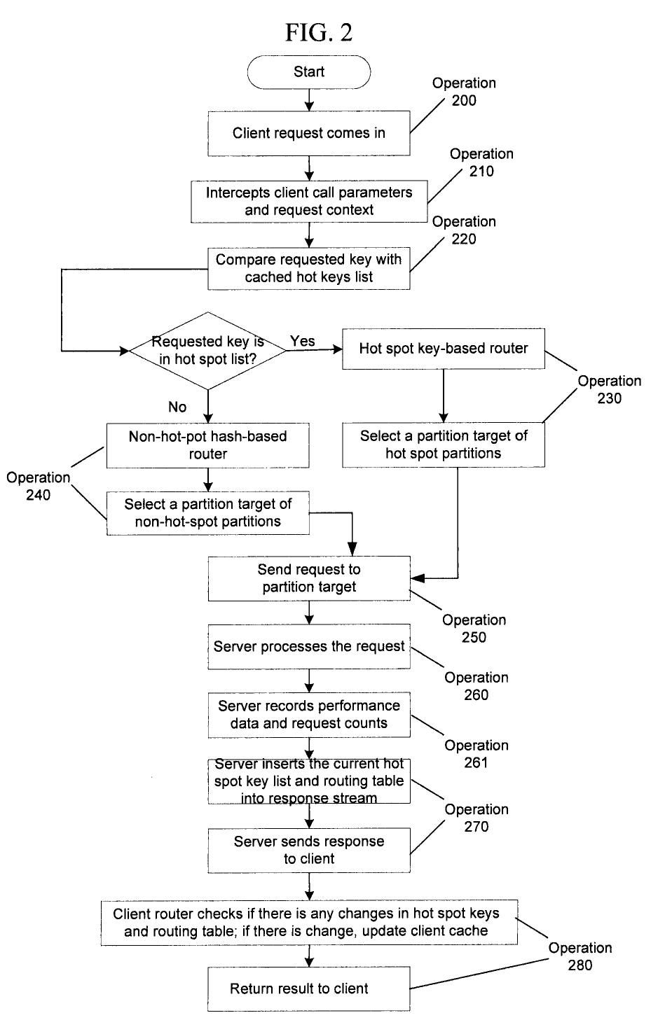

With reference to FIG. 2, in accordance with another aspect of the invention, when a client request is received (operation 200), a router, such as a hot spot router, intercepts the call parameters and context (operation 210). The hot spot router then checks to determine if the requested key is in the current hot spot key list that is cached inside the hot spot router (operation 220).

If the requested key is in the current hot spot key list, the hot spot router determines, from, e.g., a key-based routing table, the target hot pot partition from among all hot spot partitions (operation 230). If, on the other hand, the requested key is not found in the hot spot key list, then the hot spot router applies a hash based algorithm to select one of the non-hot-spot partitions as a target partition to which the request is routed (operation 240).

After finding the partition target, the hot spot router sends the request to the appropriate partition target server where the request will be processed (operation 250). Subsequently, once the targeted partition server receives the client request, the targeted partition server processes the request and creates a response stream (operation 260), records performance data and checks to determine if routing table and the current hot spot keys list have any changes (operation 261). If there are changes to be made, the changes are inserted and the response stream is sent to the client (operation 270). When the client receives the response from target partition server, the client checks to determine if there is a new hot spot keys list and a new routing table and, if there are any new changes, updates the local client hot spot key list cache and routing table cache (operation 280). In this way, the next request will efficiently use the most current hot spot keys list and routing table.

In accordance with this description, the hot spot data partitions are dynamically changed during operations. For example, for a given business day, it was expected that “GOOG” would be a very active hot spot according to historical performance data and/or anticipated events, but in actuality “GOOG” is relatively inactive while “YHOO” is relatively very active. However, “YHOO” is located in non-hot-spot data partitions because historically “YHOO” is not as active as “GOOG”. In this case, we dynamically push “GOOG” into non-hot spot partitions from hot spot partitions and pull “YHOO” from the non-hot-spot partitions to hot spot partitions. Then hot spot key lists are updated to reflect the change and new hot spot keys lists are propagated among servers. Subsequently, when client requests come in, the new hot spot keys lists are tagged into client response streams so that clients can update associated routing caches.

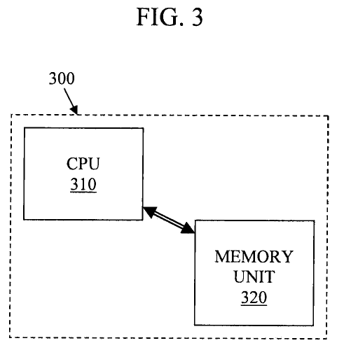

With reference to FIG. 3 and in accordance with yet another aspect of the invention, a computing system 300 is provided and includes a central processing unit (CPU) 310 and a memory unit 320 on which executable instructions are stored that cause the CPU 310 to function in several different manners. That is, the CPU 310 functions as a hybrid partitioning manager that manages different partitioning schemes for different data and for different values of various data keys, a hot spot data keys manager that picks hot spot data keys periodically according to traffic and/or performance data that was previously recorded and a hot spot data tracker that records performance metrics and thereby identifies the top 20% most active data keys (as described above, the percentage can be configurable).

In addition, the CPU 310 may also be configured to create additional in-flight hot spot partitions by using, e.g., key based partitioning of data to hot spot data keys, and to load data for these hot spot partitions before the relevant time period (e.g., before business hours). For example, it is assumed that the stock symbols IBM, MSFT and GOOG are picked as keys reflective of the most active stocks for the last seven business days or as keys that are reflective of stocks that are expected to be the most active stocks during a next business day because of financial reporting schedules or some other important events. The CPU 310 therefore creates the hot spot partitions for these keys and manages relevant data requests so that the data requests are handled on specified machines, as described above.

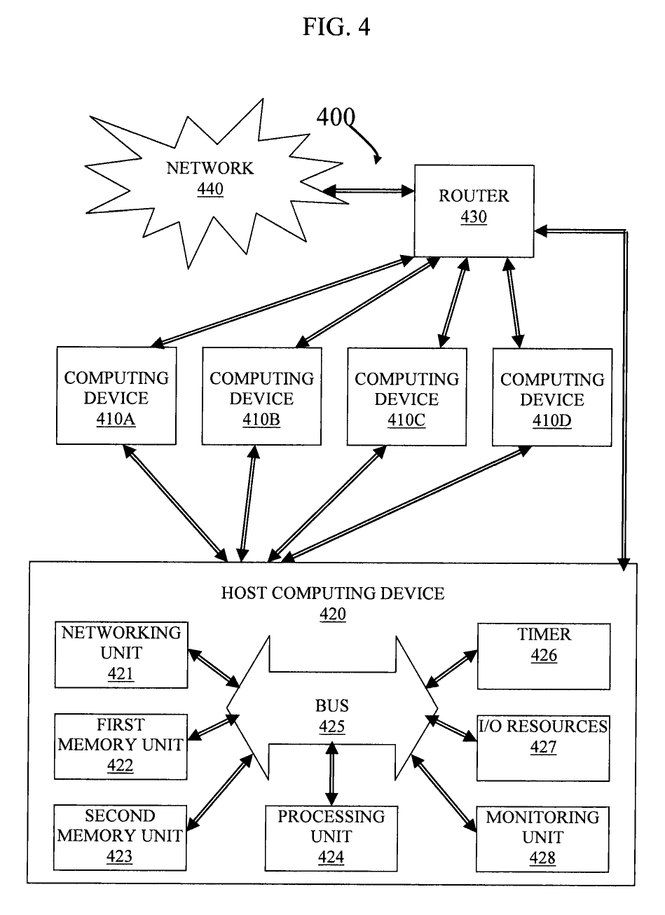

With reference now to FIG. 4, a computing system 400 is provided and includes a plurality of computing devices 410A-D, such as personal computers and/or servers, including a first set of one or more computing devices 410A, 410B and a second set of one or more computing devices 410C, 410D. Here, in accordance with an embodiment of the invention, the computing devices 410A and 410B are assumed to be more efficient and/or higher performance rated than computing devices 410C and 410D.

The computing system 400 further includes a host computing device 420, such as a personal computer and/or a server, which manages certain computing operations of the computing system 400. In this capacity, the host computing device 420 includes a networking unit 421 by which the host computing device 420 and each one of the first and second sets of computing devices 410A-D communicate with one another, a first memory unit 422 on which executable instructions are stored as, e.g., read only memory (ROM), a second memory unit 423 on which data, such as traffic and/or performance data, are stored as, e.g., random or dynamic random access memory (RAM or DRAM), a processing unit 424, and a system 425, such as a universal serial bus (USB), by which the networking unit 421, the first and second memory units 422 and 423 and the processing unit 424 are coupled to one another.

With this configuration, the processing unit 424 of the host computing device 420 accesses at least the executable instructions stored in the first memory unit 421 and thereby dynamically sets up and/or updates, based on the data, such as the traffic and/or performance data, numbers of hot spot and non-hot spot data partitions. The processing unit 424 further loads hot spot and non-hot spot data into the hot spot and non-hot spot partitions, respectively, to be handled by the first and second sets of the computing devices 410A-D, respectively.

In accordance with further embodiments of the invention, the host computing device 420 of the computing system 400 further includes a timer 426 coupled to the processing unit 424 that determines when a current period of time begins, before which the loading of the hot spot and non-hot spot data occurs, and ends, after which the data, such as the traffic and/or performance data are updated. In addition, the host computing device 420 further includes input/output (I/O) resources 427 by which hot spot and non-hot spot data requests are received by the host computing device 420 and a monitoring unit 428, such as a partition server capacity utilization monitor, to monitor at least processing resources and input/output (I/O) resources. With these additional components, the host computing device 420 is further configured to dynamically set up the hot spot and non-hot spot data partitions in accordance with first and second similar or different partitioning schemes and to dynamically update the numbers of the hot spot and non-hot spot data partitions based on current measurements of at least processing resources and input/output (I/O) resources.

Still referring to FIG. 4, the computing system 400 also includes at least one router 430 which is coupled to and disposed in signal communication with the computing devices 410A-D, the host computing device 420 and/or a network 440. As such, the at least one router 430, which may include, e.g., an on-demand router, is configured to route hot spot data requests to the first set of computing devices 410A and 410B and to route non-hot spot data requests to the second set of computing devices 410C and 410D.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A computer readable medium having executable instructions stored thereon to execute a database partitioning method during a current period of time, the database partition method comprising:
picking current hot spot data keys according to available data;
creating hot spot partitions, respectively associated with the hot spot data keys, into which hot spot data is loaded before a start time of the current period of time and creating non-hot spot partitions into which non-hot spot data is loaded before the start time;
routing hot spot data requests to the hot spot partitions and non-hot spot data requests to the non-hot spot partitions; and
monitoring computing resources to determine if a number of the hot spot partitions is to be increased or decreased and, accordingly, increasing or decreasing the number of the hot spot partitions.

2. The method according to claim 1, wherein the picking of the current hot spot data keys is periodic.

3. The method according to claim 1, wherein the current hot spot data keys are picked in accordance with a configurable percentage of most active keys.

4. The method according to claim 1, wherein the current hot spot data keys are picked in accordance with historical request records.

5. The method according to claim 1, wherein the current hot spot data keys are picked in accordance with anticipated events.

6. The method according to claim 1, wherein the current hot spot data keys are picked by a system administrator.

7. The method according to claim 1, wherein computing operations relating to the hot spot partitions are undertaken by preselected computing devices.

8. The method according to claim 1, further comprising partitioning the hot spot data and the non-hot spot data according to first and second different partitioning schemes.

9. The method according to claim 1, wherein the computing resources comprise processing resources and input/output (I/O) resources.

10. The method according to claim 1, further comprising:
merging data of the hot spot partitions and the non-hot spot partitions subsequent to an end time of the current period of time; and
adding traffic and/or performance data recorded during the current period of time to traffic and/or performance data recorded during previous periods of time.

11. A computer readable medium having executable instructions stored thereon to execute a database partition method for application thereof before and during a current period of time, the database partition method comprising dynamically assigning differing partitioning schemes for correspondingly differing data and data key values based on previous and current traffic and performance data.

12. A computing system, comprising:
a plurality of computing devices, including a first set of one or more computing devices and a second set of one or more computing devices;
a host computing device having executable instructions stored thereon to cause the host device to dynamically set up and/or update, based on traffic and performance data, numbers of hot spot and non-hot spot data partitions, into each of which hot spot and non-hot spot data are respectively loaded, to be handled by the first and second sets of the computing devices, respectively; and
at least one router to route hot spot data requests to the first set of computing devices and to route non-hot spot data requests to the second set of computing devices.

13. The computing system according to claim 12, wherein the host device comprises a server.

14. The computing system according to claim 12, wherein the host computing device comprises:
a networking unit by which the host computing device and each one of the first and second sets of computing devices communicate with one another;
a first memory unit on which at the executable instructions are stored;
a second memory unit on which the traffic and performance data are stored;
a processing unit configured to dynamically set up the hot spot and non-hot spot data partitions; and
a system by which the networking unit, the first and second memory units and the processing unit are coupled to one another.

15. The computing system according to claim 14, wherein the host computing device further comprises a timer to determine when a current period of time begins, before which the loading of the hot spot and non-hot spot data occurs, and ends, after which the traffic and performance data are updated.

16. The computing system according to claim 14, wherein the host computing device further comprises input/output (I/O) resources by which hot spot and non-hot spot data requests are received by the host computing device.

17. The computing system according to claim 16, wherein the host computing device further comprises a monitoring unit to monitor at least processing resources and input/output (I/O) resources.

18. The computing system according to claim 12, wherein the at least one router comprises an on-demand router.

19. The computing system according to claim 12, wherein the host device dynamically sets up the hot spot and non-hot spot data partitions in accordance with first and second different partitioning schemes.

20. The computing system according to claim 12, wherein the host device dynamically updates the numbers of the hot spot and non-hot spot data partitions based on current measurements of at least processing resources and input/output (I/O) resources.
